(19) United States
(12) Patent Application Publication
(10) Pub. No.: US 2023/0264294 A1
(43) Pub. Date: Aug. 24, 2023

(54) METHODS OF PREPARING A WORKPIECE FOR LASER BONDING

(71) Applicant: CORNING INCORPORATED, Corning, NY (US)

(72) Inventors: Sasha Marjanovic, Painted Post, NY (US); Bertrand Paris, Painted Post, NY (US); Kristopher Allen Wieland, Painted Post, NY (US)

(21) Appl. No.: 18/111,754

(22) Filed: Feb. 20, 2023

Related U.S. Application Data
(60) Provisional application No. 63/313,005, filed on Feb. 23, 2022.

(51) Int. Cl. B23K 26/244; B23K 26/324; B23K 26/57; B23K 26/082

(52) U.S. Cl. CPC B23K 26/244; B23K 26/324; B23K 26/57; B23K 26/082; B23K 2103/54

(57) ABSTRACT

A method of preparing a workpiece for laser bonding includes positioning a first metal gasket on a fixture; positioning a first surface of a substrate on the first metal gasket, wherein the fixture, the first metal gasket and the first surface of the substrate define a first cavity; applying a vacuum to the first cavity, the vacuum pulling the substrate against the first metal gasket; and directing a laser at an interface of the first metal gasket and the first surface of the substrate, wherein the laser forms a bond between the first metal gasket and the first surface of the substrate.

### CROSS-REFERENCE TO RELATED APPLICATIONS

This application claims the benefit of priority under 35 U.S.C § 119 of U.S. Provisional Application Ser. No. 63/313,005 filed on Feb. 23, 2022 the content of which is relied upon and incorporated herein by reference in its entirety.

### FIELD

The present specification generally relates to preparing a workpiece for laser bonding and, in particular, to preparing a glass and metal foil composite workpiece for laser bonding.

### BACKGROUND

Hermetically bonded glass and metal foil packages are increasingly popular for application to electronics and other devices that may benefit from a hermetic environment for sustained operation. Prior to hermetically bonding the glass and metal foil packages via a laser bonding processes, the glass and metal foil components must be positioned in contact with each other. The laser bonding process is sensitive to the space between the two parts being bonded together. This gap generally must be less than about 5 microns. Current methods of preparing the glass and metal foil packages are time consuming and utilize several optical layers, such as an optical flat, positioned on the surface of the glass opposite the metal foil, for pressing the glass onto the metal foil. Although functional, optical flats are susceptible to scratches, dirt, or other such defects. Such defects can absorb or scatter light, which prevent a good focus of the laser with sufficient energy at the precise position required for bonding. Improper focus of the laser beam leads to an incomplete or weak bond between the glass and metal foil.

Accordingly, a need exists for an alternative method to preparing a workpiece consisting of glass and metal foil for laser bonding.

### SUMMARY

A first embodiment of the present disclosure includes a method of preparing a workpiece for laser processing, the method includes: positioning a first metal gasket on a fixture; positioning a first surface of a substrate on the first metal gasket, wherein the fixture, the first metal gasket and the first surface of the substrate define a first cavity; applying a vacuum to the first cavity, the vacuum pulling the substrate against the first metal gasket; and directing a laser at an interface of the first metal gasket and the first surface of the substrate, wherein the laser forms a bond between the first metal gasket and the first surface of the substrate.

A second embodiment of the present disclosure may include the first embodiment, wherein the porous material is one of alumina, zirconia, quartz or aluminium silicate.

A third embodiment of the present disclosure may include the first embodiment to second embodiment, wherein the first metal gasket comprises one of aluminum, indium, or copper.

A fourth embodiment of the present disclosure may include the first embodiment to third embodiment, wherein the metal gasket is in direct contact with the fixture.

A fifth embodiment of the present disclosure may include the first embodiment to fourth embodiment, wherein the fixture comprises a porous material and the vacuum is applied through pores of the porous material.

A sixth embodiment of the present disclosure may include the first embodiment to fifth embodiment, wherein the fixture comprises one or more openings, the one or more openings extending through a thickness (Tg) of the fixture and the vacuum applied through the one or more openings.

A seventh embodiment of the present disclosure may include the first embodiment to sixth embodiment, wherein the first metal gasket has a thickness of about 7 microns to about 50 microns.

A eighth embodiment of the present disclosure may include the first embodiment to seventh embodiment wherein the substrate has a thickness of at least about 0.3 mm.

A ninth embodiment of the present disclosure may include the first embodiment to eighth embodiment, wherein the substrate is a glass substrate.

A tenth embodiment of the present disclosure may include the first embodiment to ninth embodiment, wherein the substrate is a composite structure.

An eleventh embodiment of the present disclosure may include the tenth embodiment, wherein the composite structure is a polymer layer between a first glass layer and a second glass layer.

A twelfth embodiment of the present disclosure may include the first embodiment to eleventh embodiment, wherein the fixture comprises a recess, and wherein an elastomeric seal is positioned within the recess, and wherein the first metal gasket directly contacts the elastomeric seal, the vacuum pulling the metal gasket against the elastomeric material.

A thirteenth embodiment of the present disclosure may include the first embodiment to twelfth embodiment, further comprising: positioning a second metal gasket atop a second surface of the substrate after directing the laser at the interface of the first metal gasket and the first surface of the substrate, wherein the laser forms a bond between the metal gasket and the first surface of the substrate; flipping the substrate to position the second metal gasket directly onto the fixture, wherein the fixture, the second metal gasket and a second surface of the substrate define a second cavity; applying a vacuum to the second cavity, the vacuum pulling the substrate against the second metal gasket; and directing the laser an interface of the second metal gasket and the second surface of the substrate wherein the laser forms a bond between the second metal gasket and the second surface of the substrate.

A fourteenth embodiment of the present disclosure may include the first embodiment to twelfth embodiment, further comprising: positioning a second metal gasket atop a second surface of the substrate prior to directing the laser at the interface of the first metal gasket and the first surface of the substrate, wherein the laser forms a bond between the metal gasket and the first surface of the substrate; flipping the substrate to position the second metal gasket directly onto the fixture, wherein the fixture, the second metal gasket and a second surface of the substrate define a second cavity; applying a vacuum to the second cavity, the vacuum pulling the substrate against the second metal gasket; directing the laser at the interface of the first metal gasket and the first surface of the substrate, wherein the laser forms a bond between the first metal gasket and the first surface of the substrate; and directing the laser an interface of the second metal gasket and the second surface of the substrate wherein the laser forms a bond between the second metal gasket and the second surface of the substrate.

A fifteenth embodiment of the present disclosure may include the first embodiment to fourteenth embodiment, wherein laser processing the workpiece utilizes a pulsed laser that has a wavelength greater than or equal 300 nm and less than or equal to 1100 nm.

A sixteenth embodiment of the present disclosure may include the first embodiment to fourteenth embodiment, wherein laser processing the workpiece utilizes a nanosecond pulsed laser, a picosecond pulsed laser, or a femtosecond pulsed laser.

A seventeenth embodiment of the present disclosure may include the first embodiment to fourteenth embodiment, wherein laser processing the workpiece utilizes a pulsed laser that has a repetition rate greater than or equal to 5 kHz and less than or equal to 1 MHz.

A eighteenth embodiment of the present disclosure may include the first embodiment to fourteenth embodiment, wherein laser processing the workpiece utilizes a pulsed laser that has a spot size greater than or equal to 5 μm and less than or equal to 50 μm.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a flow diagram of a method of preparing a workpiece for laser bonding, according to one or more embodiments shown and described herein;

FIGS. 2A-2F depict a workpiece prepared for laser bonding, according to one or more embodiments of the methods described herein;

FIG. 3 schematically depicts another step of the laser bonding method, according to one or more embodiments shown and described herein.

### DETAILED DESCRIPTION

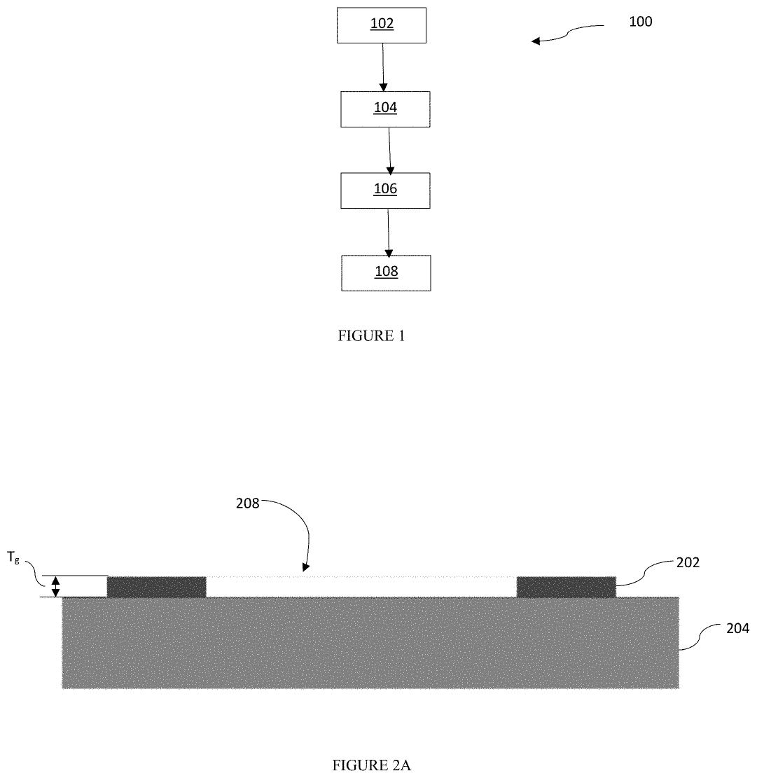

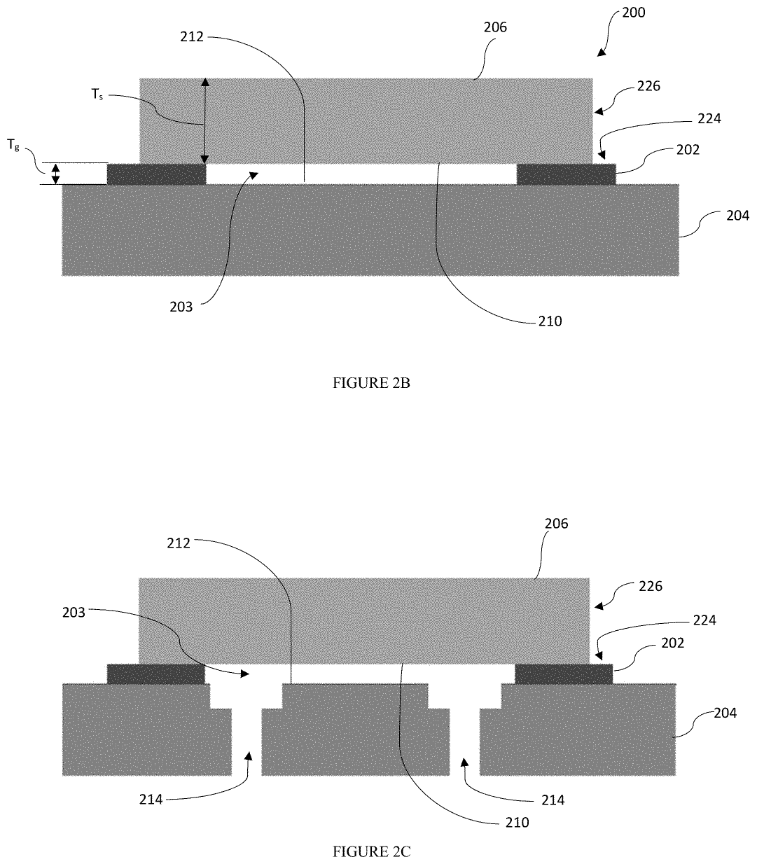

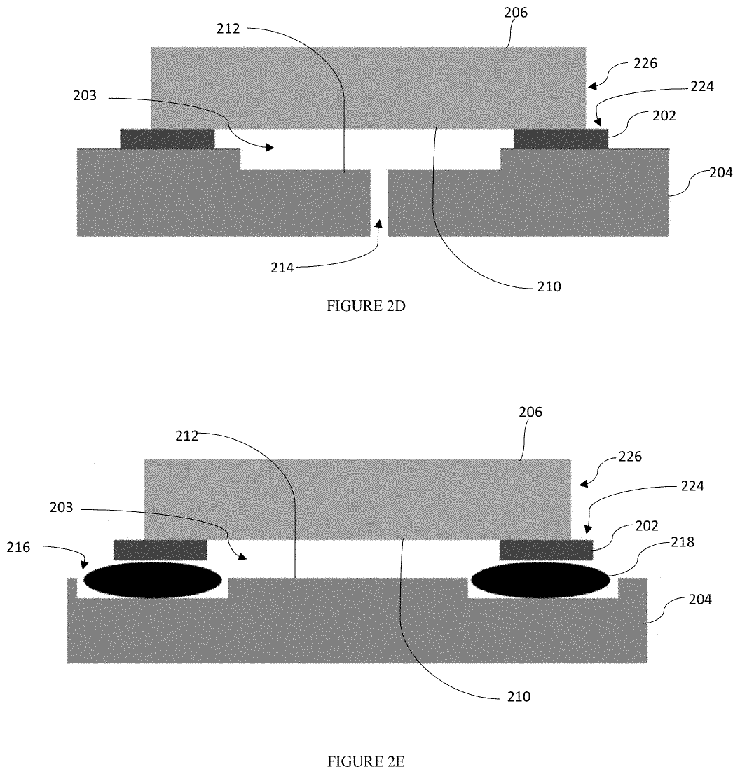

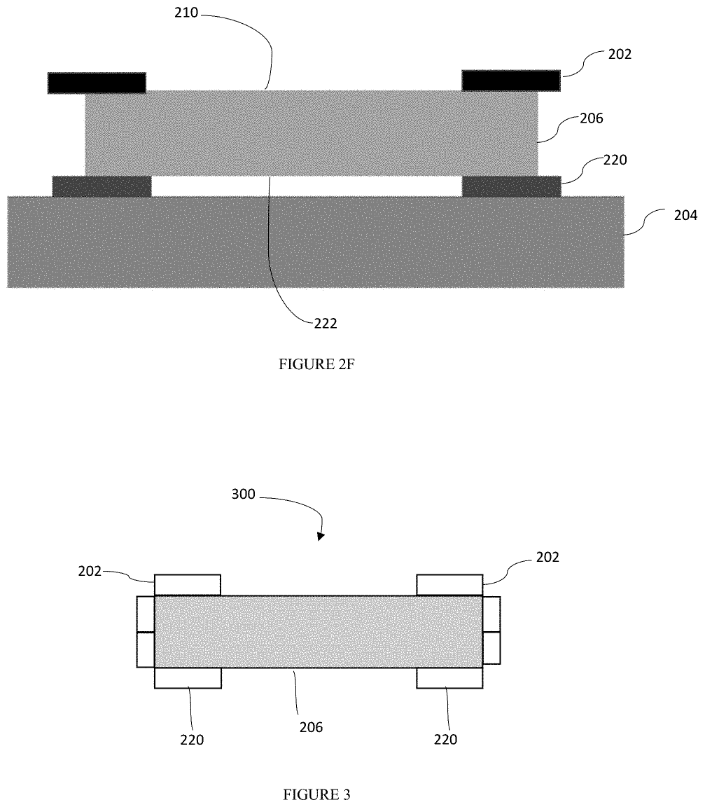

Reference will now be made in detail to various embodiments of preparing a workpiece for laser bonding. FIG. 1 depicts an embodiment of a method 100 of preparing a workpiece for laser bonding. FIGS. 2A-2F depict a workpiece prepared for laser bonding, according to one or more embodiments of the methods described herein. At block 102, a first metal gasket 202 is positioned on a fixture 204. At block 104, a first surface 210 of the substrate 206 is positioned on the first metal gasket 202. In embodiments, the first surface 210 of the substrate 206 is positioned at least partially on the first metal gasket 202 such that a portion 224 of the first metal gasket 202 extends beyond an edge 226 of the substrate 206.

In embodiments, the first metal gasket 202 has a thickness of about 7 microns to about 50 microns. In embodiments, the first metal gasket 202 has a thickness of about 10 microns to about 50 microns. In embodiments, the first metal gasket 202 has a thickness of about 20 microns to about 50 microns. In embodiments, the first metal gasket 202 has a thickness of about 30 microns to about 50 microns. In embodiments, the first metal gasket 202 has a thickness of about 40 microns to about 50 microns.

In embodiments, the first metal gasket 202 may be formed from a material that has a melting point that allows for successful bonding to the substrate 206. In embodiments, the first metal gasket 202 may comprise a melting point less than or equal to 1600° C., less than or equal to 1500° C., and less than or equal to 1400° C. In embodiments, the first metal gasket 202 may be formed from a material that is chemically compatible (i.e., readily bondable) to the substrate 206. Examples of suitable substrate materials are presented below. In embodiments, the first metal gasket 202 may be formed from a material that is substantially opaque to a selected wavelength of a laser beam. The term “substantially opaque” means that the wavelength of the laser beam is substantially absorbed when the laser beam contacts the material. For example, in embodiments, a material that is substantially opaque to a wavelength of a laser beam may be a material that exhibits an absorbance greater than or equal to 35% at the wavelength.

In embodiments, the first metal gasket 202 may have a similar average surface roughness (Ra) as the first glass substrate 206 to similarly allow the first glass substrate 206 to be placed in close contact with the metal foil 202.

In embodiments, the first metal gasket 202 may comprise aluminum, aluminum alloys, stainless steel, nickel, nickel alloys, silver, silver alloys, titanium, titanium alloys, tungsten, tungsten alloys, gold, gold alloys, copper, copper alloys, bronze, iron, or a combination thereof. In embodiments, the first metal gasket 202 may comprise a metal in combination with another non-metal material. In embodiments, a ceramic or plastic layer may be positioned between the first metal gasket 202 and the fixture 204. In embodiments, the first metal gasket 202 has an aperture 208. The first surface 212 of the fixture 204, the first metal gasket 202 and the first surface 210 of the substrate 206 define a first cavity 203.

In embodiments, the substrate 206 has a thickness of at least about 0.3 mm. In embodiments, the substrate 206 has a thickness (Tₛ) of at least about 0.5 mm. In embodiments, the substrate 206 has a thickness of at least about 1.4 mm. In embodiments, the substrate has a thickness of about 0.3 mm to about 1.4 mm. In embodiments, the substrate 206 may comprise a glass or a glass-ceramic. By way of non-limiting examples, the substrate 206 may comprise borate glass, silicoborate glass, phosphate-based glass, silicon carbide glass, soda-lime silicate glass, aluminosilicate glass, alkali-aluminosilicate glass, borosilicate glass, alkali-borosilicate glass, aluminoborosilicate glass, alkali-alumino-borosilicate glass, or alkali-aluminosilicate glass. In embodiments in which a relatively high refractive index glass (e.g., refractive index greater than or equal to 1.7 and less than or equal to 2.4) is desired, the substrate 206 may comprise borate glass, or silicoborate glass. In embodiments, the substrate 206 may be chemically strengthened, chemically tempered, and/or thermally tempered. Non-limiting examples of suitable commercially available glass substrates include EAGLE XG®, Lotus™, Willow®, and Gorilla® glasses from Corning Incorporated, including chemically strengthened, chemically tempered, and/or thermally tempered versions thereof. In embodiments, glasses and glass-ceramics that have been chemically strengthened by ion exchange may be suitable as substrates. In other embodiments, the substrate 206 may be a strengthened glass-to-glass laminate.

In embodiments, the substrate 206 may comprise a coating thereon (not shown). In embodiments, the coating may comprise a similar refractive index as the substrate 206. In embodiments, the coating may comprise a polymer coating, an antireflection (AR) coating, an oliphobic coating, an antiglare coating, or a scratch resistant coating.

In embodiments, the substrate 206 may be formed from a material that is substantially transparent to a selected wavelength of a laser beam. The term “substantially transparent” means that a wavelength of a laser beam transmits through the material without being substantially absorbed or scattered. For example, in embodiments, a material that is substantially transparent to a wavelength of a laser beam may be a material that exhibits a transmittance greater or equal to 90% at the wavelength. In embodiments, the substrate 206 may be substantially transparent to a wavelength of light greater than or equal to 300 nm and less than or equal to 1100 nm or even greater than or equal to 330 nm and less than or equal to 750 nm.

In embodiments, the substrate 206 may be subjected to surface preparation prior to positioned the substrate 206 on the first metal gasket 202. For example, in embodiments, the substrate 206 may be polished until the surfaces thereof exhibit comparatively lower surface roughness values, which may enhance bonding. In embodiments, the surfaces of the substrate 206 may be polished until the surfaces exhibit an average surface roughness (Ra) less than or equal to 1 μm, less than or equal to 0.5 μm, or even less than or equal to 0.25 μm. “Roughness,” “surface roughness (Ra),” or like terms refer to, on a microscopic level or below, an uneven or irregular surface condition, such as an average root mean squared (RMS) roughness. The smooth surface may allow the substrate 206 to be placed in close contact with the first metal gasket 202. In addition, the substrate 206 may be cleaned with water and/or solvents to remove any debris present on the surface and/or to remove any material (oil, grease, etc.) which may diminish the transparency of the substrates to the desired laser wavelengths. Removal of any debris may allow the substrate 206 to be placed in close contact with the first metal gasket 202 to better facilitate laser bonding of the first metal gasket 202 to the substrate 206.

In embodiments, the fixture 204 is a porous material. In embodiments, the fixture 204 is one of alumina, zirconia, quartz or aluminium silicate. In embodiments, as depicted in FIG. 2C and FIG. 2D the fixture has one or more openings 214 extending through a thickness (Tg) of the fixture 204. In embodiments, the fixture 204 is a porous material and has one or more openings 214. In embodiments, the fixture is non-porous material and has one or more openings 214. The one or more openings 214 are fluidly coupled to the cavity 203. In embodiments, as depicted in FIG. 2E, the fixture 204 contains a recess 216 around an edge of the fixture 204. An elastomeric seal 218 is positioned within the recess 216. The first metal gasket 202 directly contacts the elastomeric seal 218. At block 106 of method 100, a vacuum is applied to the cavity 203 to pull the substrate 206 against the first metal gasket 202. In embodiments, the vacuum within the cavity 203 is applied through the pores of the porous material of the fixture 204. In embodiments, the vacuum within the cavity 203 is applied through the one or more openings 214. The vacuum in the cavity 203 may be applied, for example, via a pump extracting air from the cavity 203. Forming a vacuum reduces the gas pressure within the cavity 203. Forming a vacuum within the cavity 203 pulls the substrate 206 downward and onto the first metal gasket 202. The substrate 208 is pulled doward with sufficient force to adhere the first metal gasket 202 onto the substrate 206 to form workpiece 200. In embodiments, a pressure of 0.1 to 2 bar of vacuum within the cavity 203 is used to pull the substrate toward the first metal gasket 202.

At block 108 of method 100, a laser is directed at an interface of the first metal gasket 202 and the first surface 210 of the substrate 206, wherein the laser forms a bond between the first metal gasket 202 and the first surface 210 of the substrate 206. In embodiments, and as depicted in FIG. 2F, prior to laser processing, the workpiece 200 having the first metal gasket 202 positioned on the first surface 210 of the substrate 206 is flipped over to position a second metal gasket 220 on the opposing second surface 222 of the substrate 206 in the same manner as described above with respect to positioning first metal gasket on the first surface 210 of the substrate 206. The second surface 222 of the substrate 206 and the first surface 210 of the substrate 206 may be then be laser processed individually. In embodiments, the first surface 210 may be laser processed, followed by flipping over the substrate 206 to position the second metal gasket 220 on the opposing second surface 222 of the substrate 206, and then laser processing the second surface 222 of the substrate 206. In embodiments, as depicted in FIG. 3 the overhang material of the first metal gasket 202 and the overhang material of the second metal gasket 220 may be folded against the edges of the substrate 206 and sealed together to produce a hermetically sealed package 300.

In embodiments, the workpiece is laser processed by directing a laser beam on at least a portion of a point of contact between the substrate 206 and the metal layer. In embodiments, the laser beam comprises a pulsed laser. In embodiments, the pulsed laser may be a nanosecond pulsed laser, a picosecond pulsed laser, or a femtosecond pulsed laser.

The method of laser bonding described herein utilizes lower energy lasers to bond the metal layer to the substrate, thereby minimizing related thermal defects in regions proximate. In embodiments, the pulsed laser may comprise a pulse energy greater than or equal to 2.8 μJ and less than or equal to 1000 μJ. In embodiments, the pulsed laser may comprise a pulse energy greater than or equal to 2.8 μJ, greater than or equal to 10 μJ, greater than or equal to 25 μJ, or even greater than or equal to 50 μJ. In embodiments, the pulsed laser may comprise a pulse energy of less than or equal to 1000 μJ, less than or equal to 750 μJ, less than or equal to 500 μJ, or even less than or equal to 250 μJ. In embodiments, the pulsed laser may comprise a pulse energy greater than or equal to 2.8 μJ and less than or equal to 1000 μJ, greater than or equal to 2.8 μJ and less than or equal to 750 μJ, greater than or equal to 2.8 μJ and less than or equal to 500 μJ, greater than or equal to 2.8 μJ and less than or equal to 250 μJ, greater than or equal to 10 μJ and less than or equal to 1000 μJ, greater than or equal to 10 μJ and less than or equal to 750 μJ, greater than or equal to 10 μJ and less than or equal to 500 μJ, greater than or equal to 10 μJ and less than or equal to 250 μJ, greater than or equal to 25 μJ and less than or equal to 1000 μJ, greater than or equal to 25 μJ and less than or equal to 750 μJ, greater than or equal to 25 μJ and less than or equal to 500 μJ, greater than or equal to 25 μJ and less than or equal to 250 μJ, greater than or equal to 50 μJ and less than or equal to 1000 μJ, greater than or equal to 50 μJ and less than or equal to 750 μJ, greater than or equal to 50 μJ and less than or equal to 500 μJ, or even greater than or equal to 50 μJ and less than or equal to 250 μJ, or any and all sub-ranges formed from any of these endpoints.

In embodiments, the pulsed laser may have a wavelength such that the substrate is substantially transparent to the wavelength of the laser beam and the metal layer is substantially opaque to the wavelength of the laser beam. For example, in embodiments the pulsed laser may have a wavelength greater than or equal to 300 nm and less than or equal to 1100 nm. In embodiments, the pulsed laser may have a wavelength greater than or equal to 300 nm, greater than or equal to 325 nm, or even greater than or equal to 350 nm. In embodiments, the pulsed laser may have a wavelength less than or equal to 1100 nm, less than or equal to 900 nm, or even less than or equal to 700 nm. In embodiments, the pulsed laser may have a wavelength greater than or equal to 300 nm and less than or equal to 1100 nm, greater than or equal to 300 nm and less than or equal to 900 nm, greater than or equal to 300 nm and less than or equal to 700 nm, greater than or equal to 325 nm and less than or equal to 1100 nm, greater than or equal to 325 nm and less than or equal to 900 nm, greater than or equal to 325 nm and less than or equal to 700 nm, greater than or equal to 350 nm and less than or equal to 1100 nm, greater than or equal to 350 nm and less than or equal to 900 nm, or even greater than or equal to 350 nm and less than or equal to 700 nm, or any and all sub-ranges formed from any of these endpoints.

In embodiments, the pulsed laser may comprise a high-repetition pulsed UV laser operating at about 355 nm, 532 nm, 1064 nm or any other wavelength that is suitable, depending on the transmission of the glass.

In embodiments, the pulsed laser may have a repetition rate greater than or equal to 5 kHz and less than or equal to 1 MHz. In embodiments, the pulsed laser may have a repetition rate greater than or equal to 5 kHz, greater than or equal to 50 kHz, greater than or equal to 100 kHz, or even greater than or equal to 250 kHz. In embodiments, the pulsed laser may have a repetition rate less than or equal to 1 MHz, less than or equal to 750 kHz, or even less than or equal to 500 KHz. In embodiments, the pulsed laser may have a repetition rate greater than or equal to 5 kHz and less than or equal to 1 MHz, greater than or equal to 5 kHz and less than or equal to 750 kHz, greater than or equal to 5 kHz and less than or equal to 500 kHz, greater than or equal to 50 kHz and less than or equal to 1 MHz, greater than or equal to 50 kHz and less than or equal to 750 kHz, greater than or equal to 50 kHz and less than or equal to 500 kHz, greater than or equal to 100 kHz and less than or equal to 1 MHz, greater than or equal to 100 kHz and less than or equal to 750 kHz, greater than or equal to 100 kHz and less than or equal to 500 kHz, greater than or equal to 250 kHz and less than or equal to 1 MHz, greater than or equal to 250 kHz and less than or equal to 750 kHz, or even greater than or equal to 250 kHz and less than or equal to 500 kHz, or any and all sub-ranges formed from any of these endpoints.

In embodiments, the pulsed laser may have a spot size greater than or equal to 5 μm and less than or equal to 50 μm. Spot size is frequently defined as the radial extent at which the intensity of the laset beam decreases to 1/e² of its maximum value. In embodiments, the pulsed laser may have a spot size greater than or equal to 5 μm or even greater than or equal to 10 μm. In embodiments, the pulsed laser may have a spot size less than or equal to 50 μm, less than or equal to 35 μm, or even less than or equal to 20 μm. In embodiments, the pulsed laser may have a spot size greater than or equal to 5 μm and less than or equal to 50 μm, greater than or equal to 5 μm and less than or equal to 35 μm, greater than or equal to 5 μm and less than or equal to 20 μm, greater than or equal to 10 μm and less than or equal to 50 μm, greater than or equal to 10 μm and less than or equal to 35 μm, or even greater than or equal to 10 μm and less than or equal to 20 μm, or any and all sub-ranges formed from any of these endpoints.

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A method of preparing a workpiece for laser processing, comprising:
positioning a first metal gasket on a fixture;
positioning a first surface of a substrate on the first metal gasket, wherein the fixture, the first metal gasket and the first surface of the substrate define a first cavity;
applying a vacuum to the first cavity, the vacuum pulling the substrate against the first metal gasket; and
directing a laser at an interface of the first metal gasket and the first surface of the substrate, wherein the laser forms a bond between the first metal gasket and the first surface of the substrate.

2. The method of claim 1, wherein the porous material is one of alumina, zirconia, quartz or aluminium silicate.

3. The method of claim 1, wherein the firstmetal gasket comprises one of aluminum, indium, or copper,

4. The method of claim 1, wherein the metal gasket is in direct contact with the fixture.

5. The method of claim 1, wherein the fixture comprises a porous material and the vacuum is applied through pores of the porous material.

6. The method of claim 1, wherein the fixture comprises one or more openings, the one or more openings extending through a thickness (Tg) of the fixture and the vacuum applied through the one or more openings.

7. The method of claim 1, wherein the firstmetal gasket has a thickness (Tg) of about 7 microns to about 50 microns.

8. The method of claim 1, wherein the substrate has a thickness of at least about 0.3 mm.

9. The method of claim 1, wherein the substrate is a glass substrate.

10. The method of claim 1, wherein the substrate is a composite structure.

11. The method of claim 10, wherein the composite structure is a polymer layer between a first glass layer and a second glass layer.

12. The method of claim 1, wherein the fixture comprises a recess, and wherein an elastomeric seal is positioned within the recess, and wherein the first metal gasket directly contacts the elastomeric seal, the vacuum pulling the metal gasket against the elastomeric material.

13. The method of claim 1, further comprising:
positioning a second metal gasket atop a second surface of the substrate after directing the laser at the interface of the first metal gasket and the first surface of the substrate, wherein the laser forms a bond between the metal gasket and the first surface of the substrate;
flipping the substrate to position the second metal gasket directly onto the fixture, wherein the fixture, the second metal gasket and a second surface of the substrate define a second cavity;
applying a vacuum to the second cavity, the vacuum pulling the substrate against the second metal gasket; and
directing the laser an interface of the second metal gasket and the second surface of the substrate wherein the laser forms a bond between the second metal gasket and the second surface of the substrate.

14. The method of claim 1, further comprising:
positioning a second metal gasket atop a second surface of the substrate prior to directing the laser at the interface of the first metal gasket and the first surface of the substrate, wherein the laser forms a bond between the metal gasket and the first surface of the substrate;
flipping the substrate to position the second metal gasket directly onto the fixture, wherein the fixture, the second metal gasket and a second surface of the substrate define a second cavity;
applying a vacuum to the second cavity, the vacuum pulling the substrate against the second metal gasket;
directing the laser at the interface of the first metal gasket and the first surface of the substrate, wherein the laser forms a bond between the first metal gasket and the first surface of the substrate; and
directing the laser an interface of the second metal gasket and the second surface of the substrate wherein the laser forms a bond between the second metal gasket and the second surface of the substrate.

15. The method of claim 1, wherein laser processing the workpiece utilizes a pulsed laser that has a wavelength greater than or equal 300 nm and less than or equal to 1100 nm.

16. The method of claim 1, wherein laser processing the workpiece utilizes a nanosecond pulsed laser, a picosecond pulsed laser, or a femtosecond pulsed laser.

17. The method of claim 1, wherein laser processing the workpiece utilizes a pulsed laser that has a repetition rate greater than or equal to 5 kHz and less than or equal to 1 MHz.

18. The method of claim 1, wherein laser processing the workpiece utilizes a pulsed laser that has a spot size greater than or equal to 5 μm and less than or equal to 50 μm.
